(19) United States
(12) Patent Application Publication
(10) Pub. No.: US 2011/0202715 A1
(43) Pub. Date: Aug. 18, 2011

(54) MANAGEMENT-PARTITIONABLE STORAGE SYSTEM, USE METHOD AND MANAGEMENT METHOD THEREOF, AND CONTROLLER THEREOF

(75) Inventor: Chien-Fu Lee, Yunlin County (TW)

(73) Assignee: PHISON ELECTRONICS CORP., Miaoli (TW)

(21) Appl. No.: 12/759,367

(22) Filed: Apr. 13, 2010

(30) Foreign Application Priority Data
Feb. 12, 2010 (TW) 99104798

(51) Int. Cl. G06F 12/02; G06F 12/00

(52) U.S. Cl. 711/112; 711/173; 711/E12.001; 711/E12.002

(57) ABSTRACT

A management partitionable storage system, a use method for the management partitionable storage system, a management method and a controller thereof are provided. Herein, whether the management-partitionable storage system is connected into a host is determined. The management-partitionable storage system includes a simulated compact disc (CD) partition and a data storage partition. When the management-partitionable storage system is coupled to the host, the simulated compact disc partition is mounted on a mount point of the host. A command is received from the mount point, wherein the command includes an identification code corresponding to the data storage partition. The command is executed to the data storage partition according to the identification code.

### CROSS-REFERENCE TO RELATED APPLICATION

This application claims the priority benefit of Taiwan application serial no. 99104798, filed on Feb. 12, 2010. The entirety of the above-mentioned patent application is hereby incorporated by reference herein and made a part of specification.

### BACKGROUND OF THE INVENTION

1. Technology Field

The present invention generally relates to a storage device mechanism, and more particularly, to a use method and a system, which are capable of directly transmitting a command to a management-partitionable storage system, and a storage unit controller.

2. Description of Related Art

Generally, an operation system mounts a storage device on a drive letter for a user to use. The user can access the storage device through the drive letter. And, an application program can transmit a small computer system interface (SCSI) command to the storage device via the driver letter.

However, because of security reasons, at a specific operation system, an application program can not transmit a SCSI command to the storage device via the driver letter, directly. For example, at a MAC platform, an application program that is not built-in the MAC platform is not permitted to transmit a SCSI command to the storage device. Therefore, users must install a specific driver at the MAC platform, and thereby the application program may transmit a SCSI command to the storage device. Similarly, at a Linux platform, only an application program that is authenticated can transmit a SCSI command to the storage device via the mount point mounted for the storage device.

Accordingly, if the storage device is set to be at a write protect status because of the security reasons and a user is about to use an application program corresponding to the storage device to unlock the storage device, the application program will not unlock the storage device via the mount point, directly.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a use method for a management-partitionable storage system, which is capable of giving a command to the management-partitionable storage system via a mount point of a simulated compact disc partition.

The present invention is directed to a management-partitionable storage system, wherein the management-partitionable storage system includes a simulated public storage device partition and a data storage partition and uses the data storage partition by giving a command to the simulated public storage device partition.

The present invention provides a storage unit controller capable of directly accessing a storage unit.

According to an exemplary embodiment of the present invention, a use method for a management-partitionable storage system is provided as the follows. Whether the management-partitionable storage system is connected into a host is determined. The management-partitionable storage system includes a simulated compact disc (CD) partition and a data storage partition. When the management-partitionable storage system is coupled to the host, the simulated compact disc partition is mounted on a mount point of the host. The management-partitionable storage system receives a command including an identification code corresponding to the data storage partition from the mount point, and thereby executes the command to the data storage partition according to the identification code.

According to an exemplary embodiment of the present invention, a management method for managing a simulated public storage device partition and a data storage partition of a storage system is provided as the follows. The simulated public storage device is used for simulating a public storage device and the public storage device is different from the above-mentioned storage device. Herein, the simulated public storage device partition is mounted on a mount point of a host when the storage system is coupled to the host. A command is received from the mount point, and whether the command is used for opening the data storage partition is determined. And, the data storage partition is provided to the host for mounting on another mount point when the command is used to open the data storage partition.

According to an exemplary embodiment of the present invention, a use method for using a simulated public storage device partition and a data storage partition of a storage system is provided as the follows. The simulated public storage device is used for simulating a public storage device and the public storage device is different from the above-mentioned storage device. Herein, an authentication procedure is provided when the storage system is connected to a mount point of a host. The mount point corresponds to the simulated public storage device partition. And, when the authentication procedure is passed, an access permission command is sent via the mount point, and thereby the data storage partition of the storage system is mounted on another mount point.

According to an exemplary embodiment of the present invention, a management-partitionable storage system including a storage unit, a connector and a storage unit controller is provided. The storage unit includes a simulated compact disc (CD) partition and a data storage partition. The connector is coupled to a host system and configured to receive digital data. When the connector is coupled to the host, the simulated compact disc partition is mounted on a mount point of the host. The storage unit controller is coupled to the storage unit and the connector and configured for receiving a command from the mount point and determining whether the command includes an identification code corresponding to the data storage partition, and thereby executing the command to the data storage partition when the command includes the identification code corresponding to the data storage partition.

According to an exemplary embodiment of the present invention, a storage unit controller for managing a management-partitionable storage system is provided. The storage unit controller comprises a storage unit interface unit, a host interface unit and a storage unit management circuit. The storage unit interface unit is coupled to the storage unit. The host interface unit is coupled to a host and configured for receiving digital data. The storage unit management circuit is configured for, after the simulated compact disc partition of the management-partitionable storage system is mounted on a mount point of the host, receiving a command from the mount point; determining whether the command includes an identification code corresponding to the data storage partition; and executing the command to the data storage partition when the command includes the identification code corresponding to the data storage partition.

Based on the above, because an application program only gives commands to the simulated compact disc partition, the application program can actually execute a command to the data storage partition by giving the command to the simulated compact disc partition according to the above-mentioned method. Accordingly, the application program is capable of transmitting commands to the management-partitionable storage system, directly.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram illustrating a host using a management-partitionable storage system according to an exemplary embodiment of the present invention.

FIG. 1B illustrates a diagram of a computer, an input/output (I/O) device, and a management-partitionable storage system according to an exemplary embodiment of the invention.

FIG. 1C is a schematic block diagram illustrating a management-partitionable storage system according to an exemplary embodiment of the present invention.

FIG. 2A is a schematic block diagram illustrating a management-partitionable storage system and a host according to an exemplary embodiment of the present invention.

FIG. 2B is a schematic block diagram illustrating a storage unit controller according to an exemplary embodiment of the present invention.

FIG. 3 is a diagram of using a management-partitionable storage system according to an exemplary embodiment of the present invention.

FIG. 4 is a flower chart illustrating a use method for a management-partitionable storage system according to an exemplary embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Because of security reasons, at a specific operation system (e.g., a MAC platform or a Linux platform), an application program can not transmit a computer interface command to a management-partitionable storage system, directly. Therefore, users just transmit the computer interface command to non-optical storage device after installing a specific driver or acquiring an authorization from the operation system. Accordingly, the present invention provides a management-partitionable storage system, a use method for the management-partitionable storage system and a storage unit controller thereof, such that an application program is capable of directly transmitting a computer interface command to the management-partitionable storage system. It should be understood that in the present disclosure, for example, the computer interface command is a serial advanced technology attachment (SATA) command, a parallel advanced technology attachment (PATA) command or a small computer system interface (SCSI) command. Additionally, for example, the management-partitionable storage system is a non-optical storage device. For example, the non-optical storage device is a device that uses magnetic medium (e.g., a hard disk) or electric charges to store digital data (e.g., a flash memory system). Furthermore, in the present disclosure, the operation system is a program that managing computer hardware resources and computer software resources. And, the application program is software that processing a specific purpose for a user. For example, the application program is used for an information security management.

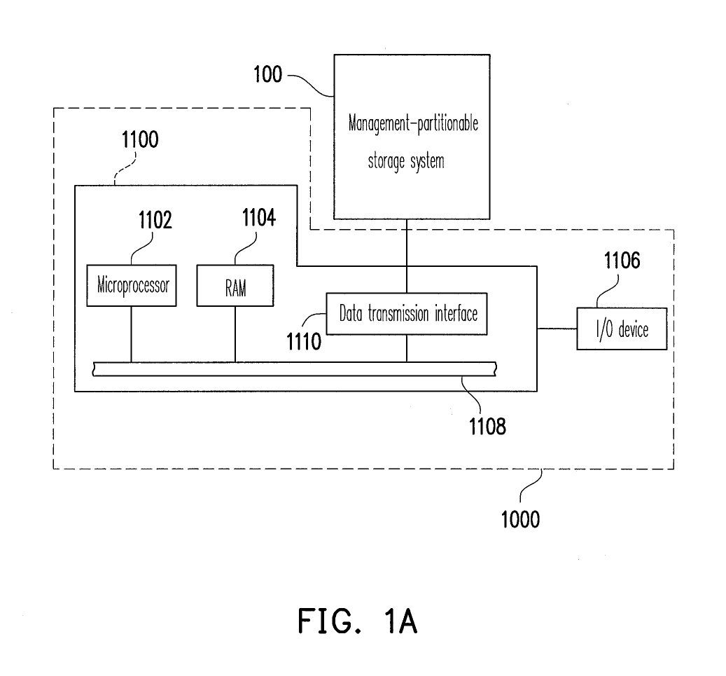

FIG. 1A is a schematic block diagram illustrating a host using a management-partitionable storage system according to an exemplary embodiment of the present invention. FIG. 1B illustrates a diagram of a computer, an input/output (I/O) device, and a management-partitionable storage system according to an exemplary embodiment of the invention. In present exemplary embodiment, a management-partitionable storage system 100 is a system in which a storage medium can be divided in a plurality of areas and the areas are provided respectively based on an authority of a user or storage data thereon. For example, the management-partitionable storage system 100 is a flash memory storage device or a hard disk.

Referring to FIG. 1A, a host 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 1B. It should be understood that the devices illustrated in FIG. 1B are not intended to limit the scope of the I/O device 1106, and the I/O device 1106 may further include other devices.

In the present exemplary embodiment, the management-partitionable storage system 100 is coupled to the devices of the host 1000 through the data transmission interface 1110. By using the microprocessor 1102, the random access memory (RAM) 1104 and the Input/Output (I/O) device 1106, the data can be write into the management-partitionable storage system 100 or can be read from the management-partitionable storage system 100. For example, the management-partitionable storage system 100 may be a flash drive 1212 or a solid state drive (SSD) 1216, as shown in FIG. 1B.

FIG. 1C is a schematic block diagram illustrating a management-partitionable storage system according to an exemplary embodiment of the present invention. Referring to FIG. 1C, the management-partitionable storage system 100 includes a connector 1311, and a storage unit 1315 and a storage unit controller 1313. The management-partitionable storage system 100 connects to the host 1000 through the connector 1311, and the storage unit controller 1313 connects to the storage unit 1315 and the connector 1311.

In the present exemplary embodiment, the storage unit 1315 includes a simulated public storage device partition 1317 and a data storage partition 1319. Herein, the simulated public storage device partition 1317 of the storage unit 1315 is announced as a public storage device by the storage unit controller 1313. The public storage device is different from the management-partitionable storage system 100. For example, the public storage device may be an optical storage device that uses a laser or an electromagnetic wave closing to a spectrum to write or read data, such as a compact disc (CD), a digital video disc (DVD) or a blue-ray disc drive, and the specification thereof is one of a CD-ROM drive, a CD-R drive, a CD-RW drive, a DVD-R drive, a DVD-RW drive, a DVD-ROM drive and a blue-ray disc drive. In should be noted that the specification of the optical storage device may be varied based on different operation systems. For example, for the MAC platform, the specification of the optical storage device may be the CD-R drive or the CD-RW drive. And, for the Linux platform, the specification of the optical storage device further includes the CD-ROM drive.

Detailed explanations with another exemplary embodiment are given below. In order to describe conveniently, a partition used for simulating a public storage device in the storage unit 1315 is referred as a simulated compact disc partition 227 thereafter.

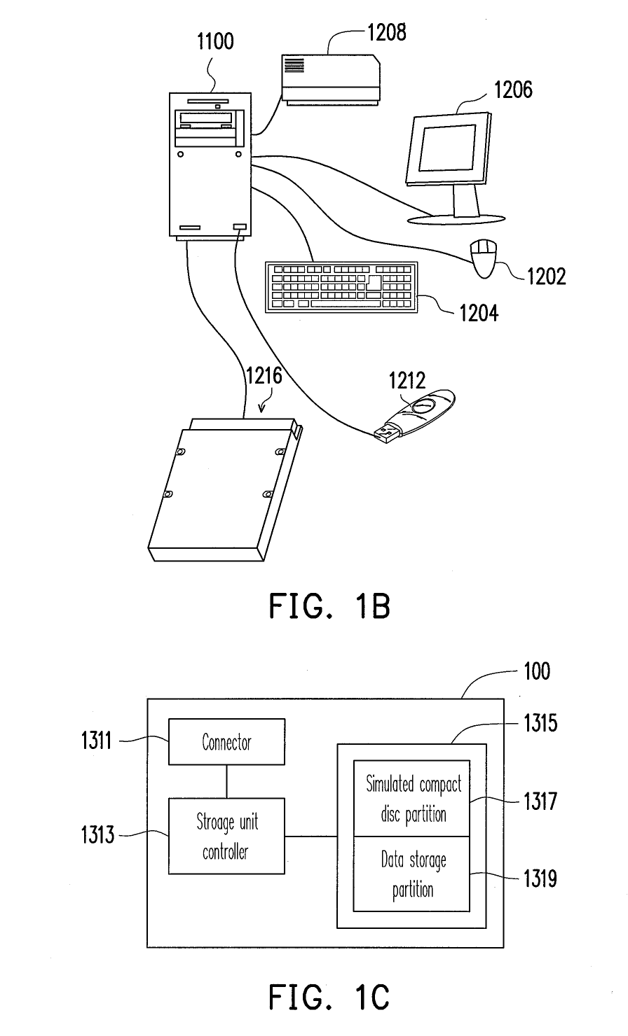

FIG. 2A is a schematic block diagram illustrating a management-partitionable storage system and a host according to an exemplary embodiment of the present invention. Referring to FIG. 2, the management-partitionable storage system 100 includes a connector 221, and a storage unit 225 and a storage unit controller 223. The management-partitionable storage system 100 could connect to the host 1000 through the connector 221, and the storage unit controller 223 connects to the storage unit 225 and the connector 221.

In the present exemplary embodiment, the storage unit 225 includes the simulated compact disc partition 227 and a data storage partition 229. Herein, the simulated compact disc partition 227 of the storage unit 225 is announced as a public storage device (e.g., the CD drive, the DVD drive or the blue-ray disc drive) by the storage unit controller 223.

When the management-partitionable storage system 100 is connected to the host 1000 through the connector 221, the host 1000 configures a mount point and mounts the simulated compact disc partition on the mount point. For a windows platform, the mount point could be a drive letter mapped to a device. And, for the MAC platform, the mount point could be an address in a system directory, such as a driver interface or a UNIX mount point. Accordingly, the storage unit controller 223 may receive a command from the host 1000 via the mount point. If the command includes an identification code corresponding to the data storage partition 229, the storage unit controller 223 executes the command to the data storage partition 229 according to the identification code. For example, the command is a SCSI command and the identification code is a logical unit number (LUN).

In another exemplary embodiment, besides the simulated compact disc partition 227, the storage unit 225 also includes two or more than two data storage partitions 229. And, the storage unit controller 223 determines a data storage partition to be executed a command based on the identification code of the command.

Additionally, the host 1000 further includes an application program 211. The application program is used for giving a command in the host 1000 and transmitting the command to the management-partitionable storage system 100 via the mount point. For example, the application program 211 is a software program code, which is recorded in a recordable medium or the management-partitionable storage system 100, or is stored in a network platform for downloading by the host.

In the present exemplary embodiment, the host 1000 configures another mount point for mounting the data storage partition 229 after the authority of using the data storage partition 229 (also referred to “the use authority” of the data storage partition 229) is opened. Herein, the authority of using the data storage partition 229 may be opened by giving an access permission command for the data storage partition 229 through the current mount point (i.e., the simulated compact disc 227) of the management-partitionable storage system 100 by the application program 211 installed in the host after an authentication procedure is executed.

FIG. 2B is a schematic block diagram illustrating a storage unit controller according to an exemplary embodiment of the present invention. Referring to FIGS. 2A and 2B, the storage unit controller 223 includes a storage unit interface unit 235, a host interface unit 231 and a storage unit management circuit 233.

The storage unit interface unit 235 is coupled to the storage unit 225. The host interface unit 231 is coupled to the host 1000 and configured to receive digital data. The storage unit management circuit 233 is configured for, after the simulated compact disc partition 277 of the management-partitionable storage system 100 is mounted on the mount point of the host 1000, receiving a command from the mount point; determining whether the command includes the identification code corresponding to the data storage partition 229 of the management-partitionable storage system 100; and executing the command to the data storage partition 229 when the command includes the identification code corresponding to the data storage partition 229.

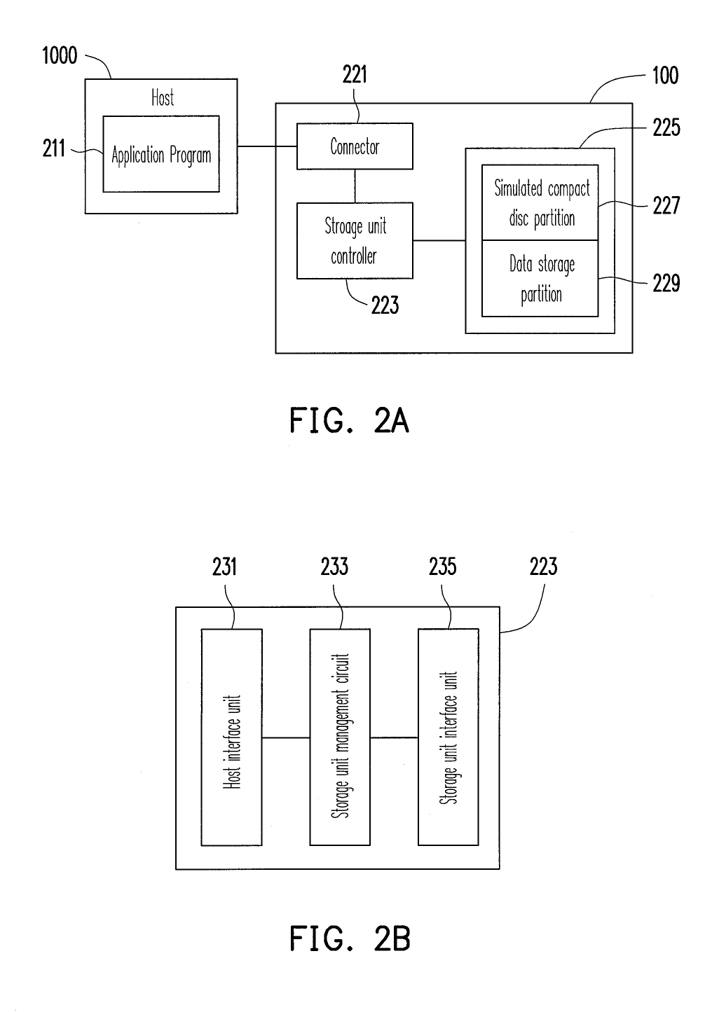

Another exemplary embodiment is given for explaining how to use management-partitionable storage system as the follows. FIG. 3 is a diagram of using a management-partitionable storage system according to an exemplary embodiment of the present invention. Referring to FIG. 3, after an operation system 301 mounts the simulated compact disc partition 227 on the mount point “D”, the application program 211 may open the authority of using the data storage partition 229 via the mount point “D”. Herein, a computer interface command (e.g., the access permission command) transmitted by the application program 211 is transmitted to the simulated compact disc partition 227 of the management-partitionable storage system 100. Herein, the simulated compact disc partition 227 is announced as an optical storage device and a command format thereof complies with the format of the optical storage device. Accordingly, the computer interface command transmitted by the application program 211 can be transmitted by the operation system and the computer interface command is accepted by the management-partitionable storage system 100. For example, the application program 211 may indicate the data storage partition 229 to be opened in the access permission command. For example, the access permission command is “FF,0A,LUN”, wherein “LUN” is a logical unit number for indicating the data storage partition 229 to be un-locked the authority. After the authority of the data storage partition 229 is un-locked, the storage unit controller 223 re-announces the status of the management-partitionable storage system 100. For example, the storage unit controller 223 adjusts a register bit indicating that “a media is changed” for informing the operation system 301 that the status of the management-partitionable storage system 100 is changed. When the operation system 301 identifies that the status of the management-partitionable storage system 100 is changed, the operation system 301 re-confirms and configures another mount point “E” for a new storage space (i.e., the data storage partition 229) and mounts the data storage partition 229 on the mount point “E”. Accordingly, the operation system 301 can access the data storage partition via the mount point “E”, directly. In another exemplary embodiment, after management-partitionable storage system 100 announces that a media is changed, the management-partitionable storage system 100 may remove the original mount point “D” and configures the new mount point “E”.

In an actual application, the connector 221 may also be a serial advanced technology attachment (SATA) connector, a universal serial bus (USB) connector, an Institute of Electrical and Electronic Engineers (IEEE) 1394 connector, a peripheral component interconnect (PCI) express connector an integrated device electronics (IDE) connector, or other suitable connectors.

Additionally, for example, the storage unit 225 is a multi-level cell (MLC) NAND flash memory. Nevertheless, it should be understood that the present invention is not limited thereto. In another exemplary embodiment of the present invention, a single level cell (SLC) NAND flash memory may also be applied to the present invention.

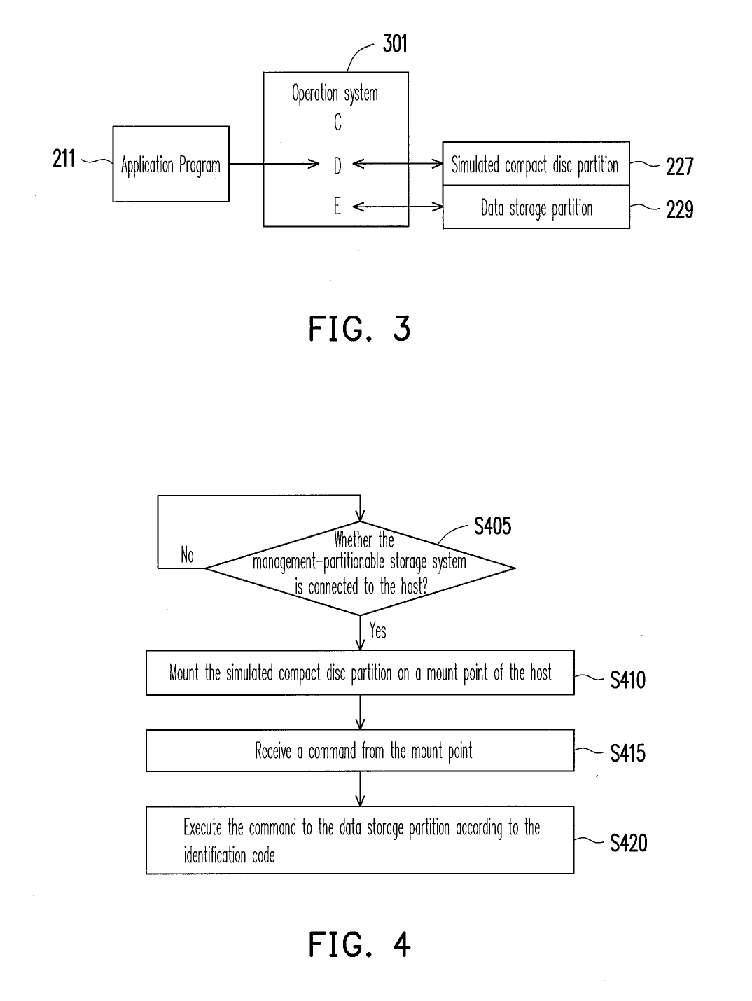

FIG. 4 is a flower chart illustrating a use method for a management-partitionable storage system according to an exemplary embodiment of the present invention. Referring to FIGS. 2A, 2B, 3 and 4, as shown in step S405, whether the management-partitionable storage system is connected to the host 1000 is determined. To be specific, in the host 1000, the operation system 301 detects whether the management-partitionable storage system is connected to the host 1000 is determined. Herein, the management-partitionable storage system 100 includes the simulated compact disc partition 227 and the data storage partition 229.

When the management-partitionable storage system 100 starts to connect to the host, as shown in S410, the simulated compact disc partition 227 is mounted on a mount point of the host 1000 and the data storage partition 229 is not mounted on the host 1000. For example, when the operation system 301 detects that the management-partitionable storage system 100 connects to the host, the operation system 301 configures a mount point (e.g., the mount point “D”) and mounts the simulated compact disc partition 227 of the management-partitionable storage system 100 on the mount point.

After that, in step S415, the management-partitionable storage system 100 receives a command (e.g., a SCSI command) via the mount point. That is, the application program 211 is capable of giving a command of the simulated compact disc partition 227 to the management-partitionable storage system 100 via the mount point “D”, directly. And, the operation system of the host 1000 permits the transmission of the command because the command is given to the simulated compact disc partition 227 announced as a compact disc drive. Herein, for example, the application program 211 is used for an information security management and may transmit a command for opening security blocks (e.g., data storage partition 229) to the management-partitionable storage system 100 after a user passes the authentication procedure.

Herein, when the management-partitionable storage system 100 receives the command from the mount point, the storage unit controller 1313 of the management-partitionable storage system 100 identifies whether the command includes an identification code corresponding to the data storage partition 229. When the command includes the identification code corresponding to the data storage partition 229, the management-partitionable storage system 100 executes the command to the data storage partition 229 according to the identification code, as shown step S420. To be specific, a command given by the application program includes one identification code. And, when receiving the command, the management-partitionable storage system 100 determines whether the command is for the data storage partition 229 according to the identification code.

In an actual application, for example, the management-partitionable storage system 100 is a flash memory storage device. And, when the flash memory storage device is at a write protect status or a secret status, and a user is about to write data into the flash memory storage device or read data from the flash memory storage device, the application program 211 is needed for un-locking the flash memory storage device. However, under the write protect status or the secret status, the operation system 301 can not give a write command to the data storage partition 229, directly. That is, the operation system 301 does not stop a command given by itself. However, when the operation system 301 executes a write command to the flash memory storage device (i.e., management-partitionable storage system 100), the flash memory storage device stops the command. Accordingly, the application program 211 is needed for unlocking the write protect status of the flash memory storage device.

However, the operation system 301 stops a command given by the application program 211 that is not built-in the operation system 301. Accordingly, the data storage partition 229 will be un-locked by the above-mentioned step S405˜S420. Then, the operation system 301 is capable of accessing the data storage partition 229, directly.

In summary, in the management-partitionable storage system according to the present, a simulated compact disc partition is configured additionally and a command is given to the simulated compact disc partition, wherein a target of the command is a data storage partition of the management-partitionable storage system. Accordingly, in the above-mentioned specific operation system, specific blocks of the management-partitionable storage system are used directly without installing an additional driver or using a root authority, and thereby it is more convenient to use the management-partitionable storage system. The previously described exemplary embodiments of the present invention have the advantages aforementioned, wherein the advantages aforementioned not required in all versions of the invention.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A use method for a management-partitionable storage system, comprising:
determining whether the management-partitionable storage system is coupled to a host, wherein the management-partitionable storage system includes a simulated compact disc partition and a data storage partition;
mounting the simulated compact disc partition on a mount point of the host when the management-partitionable storage system is coupled to the host;
receiving a command from the mount point, wherein the command includes an identification code corresponding to the data storage partition; and
executing the command to the data storage partition according to the identification code.

2. The use method according to claim 1, wherein the command is given in the host by an application program and transmitted to management-partitionable storage system via the mount point.

3. The use method according to claim 1, wherein the command is an access permission command, and the step of executing the command to the data storage partition comprises opening a use authority of the data storage partition corresponded to the identification code according to the access permission command.

4. The use method according to claim 3, further comprising: mounting the data storage partition on another mount point of the host after the step of opening the use authority of the data storage partition corresponded to the identification code.

5. The use method according to claim 1, wherein the command is a small computer system interface (SCSI) command.

6. The use method according to claim 1, wherein the identification code is a logical unit number.

7. A management method for managing a simulated public storage device partition and a data storage partition of a storage system, wherein the simulated public storage device partition is used to simulate a public storage device and the public storage device is different from the storage system, the management method comprising:
mounting the simulated public storage device partition on a mount point of a host when the storage system is coupled to the host;
receiving a command from the mount point;
identifying whether the command is used to open the data storage partition, and providing the data storage partition to the host for mounting on another mount point when the command is used to open the data storage partition.

8. The management method according to claim 7, wherein the step of identifying whether the command is used to open the data storage partition comprises:
determining whether the command includes an identification code corresponding to the data storage partition, and opening a use authority of the data storage partition corresponded to the identification code when the command includes the identification code.

9. A use method for using a simulated public storage device partition and a data storage partition of a storage system, wherein the simulated public storage device partition is used to simulate a public storage device and the public storage device is different from the storage system, the use method comprising:
providing an authentication procedure when the storage system is connected to a mount point of a host, wherein the mount point corresponds to the simulated public storage device partition; and
sending an access permission command via the mount point to mount the data storage partition of the storage system on another mount point when the authentication procedure is passed.

10. The use method according to claim 9, wherein the access permission command includes an identification code corresponding to the data storage partition.

11. A storage system, comprising:
a storage unit, including a simulated public storage device partition and a data storage partition, wherein the simulated public storage device partition is used to simulate a public storage device and the public storage device is different from the storage system;
a connector, configured to couple to a host and receive digital data, wherein the simulated public storage device partition is mounted on a mount point of the host when the connect is coupled to the host; and
a storage unit controller, coupled to the storage unit and the connector and configured to:
receive a command from the mount point;
identify whether the command includes an identification code corresponding to the data storage partition; and
execute the command to the data storage partition when the command includes the identification code corresponding to the data storage partition.

12. The storage system according to claim 11, wherein the command is an access permission command, and the storage unit controller opens a use authority of the data storage partition corresponded to the identification code.

13. The storage system according to claim 12, wherein the storage unit controller announces that a status of the storage system is changed to the host after the use authority of the data storage partition corresponded to the identification code is opened.

14. The storage system according to claim 12, wherein the data storage partition is mounted on another mount point of the host after the use authority of the data storage partition corresponded to the identification code is opened.

15. The storage system according to claim 11, wherein the command is a small computer system interface (SCSI) command.

16. The storage system according to claim 11, wherein the identification code is a logical unit number.

17. The storage system according to claim 11, wherein the storage system is a non-optical storage device, and the simulated public storage device partition is used to simulate an optical storage device.

18. A storage unit controller, for managing a management-partitionable storage system, the storage unit controller comprising:
a storage unit interface unit, coupled to the management-partitionable storage system;
a host interface unit, coupled to a host and configured to receive digital data; and
a storage unit management circuit, configured to:
receive a command form a mount point of the host after a simulated compact disc partition of the management-partitionable storage system is mounted on the mount point;
identify whether the command includes an identification code corresponding to a data storage partition; and
execute the command to the data storage partition when the command includes the identification code corresponding to the data storage partition.

19. The storage unit controller according to claim 18, wherein the command is an access permission command, and the storage unit management circuit opens a use authority of the data storage partition corresponded to the identification code.

20. The storage unit controller according to claim 19, wherein the storage unit management circuit announces that a status of the management-partitionable storage system is changed to the host after the use authority of the data storage partition corresponded to the identification code is opened.
